(19) United States
(12) Patent Application Publication
(10) Pub. No.: US 2019/0290403 A1
(43) Pub. Date: Sep. 26, 2019

(54) DENTAL IMPLANT SYSTEM

(71) Applicant: Z-Systems AG, Oensingen (CH)

(72) Inventor: Ernst Thomke, Grenchen (CH)

(21) Appl. No.: 16/359,167

(22) Filed: Mar. 20, 2019

(30) Foreign Application Priority Data
Mar. 22, 2018 (CH) 00391/18

(51) Int. Cl. A61C 8/00

(52) U.S. Cl. CPC A61C 8/0068; A61C 8/0051; A61C 8/008; A61C 8/006; A61C 8/0012; A61C 8/0074; A61C 8/0018; A61C 8/0069

(57) ABSTRACT

A dental implant system includes an anchoring part of a ceramic material for anchoring in bone tissue, an abutment of ceramic material, and an abutment screw. The anchoring part has a recess that is open towards a coronal end for engagement of a fastening post of the abutment. The abutment has an opening that is continuous in the axial direction and into which the abutment screw can be inserted. The abutment screw is configured, for a fastening of the abutment to the anchoring part, to engage into an inner thread that is formed on the anchoring part in the recess or is present on an insert element that is inserted into the recess. The abutment screw has a screw head, and a shoulder, which is formed coronally and which together with the screw head forms a stop on inserting the screw into the opening, is present in the opening.

### BACKGROUND OF THE INVENTION

### Field of the Invention

The invention relates to the field of medical technology. It also relates to a dental implant system.

### Description of Related Art

Two-part implant systems are widespread amongst dental implant systems. These include the actual implant (also called “anchoring part” or, if it is provided with a thread, “screw”) and an abutment which is provided for fastening thereto. The anchoring part can herein be designed such that it is introduced roughly flush with the bone surface (as a so-called bone-level implant), or it can be provided with a region coronally of the bone surface, the region often being widened with respect to the enossal region, which is generally provided with a thread, sometimes being called a “tulip” and being envisaged to reach to roughly the gum surface. Implants with such a transgingival region are called “tissue level” implants. The region (“post”) that projects out of the gums and serves for the fastening of a superstructure, thus a crown, bridge or prosthesis or the like, in the two-part implant system is formed by the abutment.

Apart from the well-established titanium, ceramic materials are gaining increasing significance, amongst these in particular zirconium oxide ceramics (also called “zirconium” which scientifically is not entirely correct). Ceramic implants have aesthetic advantages due to their colour, and furthermore they encourage the integration of bone tissue and gingival tissue on the implant surface particularly well and are often met with a greater acceptance by patients than metallic implants. However, they have the disadvantage that they are brittle-hard and in contrast to the more ductile metallic implants have a tendency to brittle fracture given large mechanical loads, which is also why not all implant shapes can be manufactured without further ado.

Concerning two-part implant systems, there are various possibilities for fastening the abutment to the anchoring part. A screw, which is termed abutment screw in this text, is often used in titanium-based systems, and this screw is led through a recess in the abutment, the recess being accessible from the coronal side, and engages into a thread in the anchoring part. The head of the abutment screw bears on a shoulder, which is formed in the mentioned recess of the abutment, and on account of this presses the abutment against the anchoring part and its fastening post into the recess of the anchoring part provided for this.

Inherent of its design, such an abutment screw exerts very high forces locally on certain structures of the anchoring part and of the abutment, which is why although being very widespread in titanium-based systems, it would however often lead to a failure in the case of brittle-hard ceramic implant systems. For this reason, ceramic systems are most bonded, i.e. the abutment is fastened to the anchoring part by way of an adhesive, which entails the known disadvantages of adhesive connections.

US 2014/0272791 discloses a dental implant system with an implant of titanium and with an abutment, wherein ceramic materials are mentioned as alternatives. An interference fit connection exists between the implant and the abutment by way of using a Morse taper. A screw, whose head abuts on a step in the inside of the abutment, serves for fastening the abutment to the implant.

The publication JPH09 66065 discloses a dental implant system with metallic implants and abutments, optionally with a coating of hydroxyapatite or ceramic. A screw, whose head is conical at the lower side, serves for fastening the abutment to the implant, wherein the conical surface comes into contact with an inner thread of the abutment if the screw is screwed in up to the stop. In this configuration, a shoulder of the abutments abuts on a coronal-end-face end surface of the implant.

The solution of JPH09 66065 with a conical surface of the implant head that is pressed against the inner thread leads to the screw abutting on the abutment at only one side and only along a short line due to the course of the thread, which leads to locally very high stress peaks. This solution is not suitable for ceramic abutment materials or would at least entail huge disadvantages and an intolerably high probability of failure.

A two-part bone-level implant system based on ceramic is described in WO 2017/096494, concerning which an abutment screw is held with the help of an insert element, which is mounted in the recess of the anchoring part.

### SUMMARY OF THE INVENTION

It is the object of the present invention to provide a two-part implant system with an anchoring part and abutment, which overcomes the disadvantages of the state of the art and in particular is designed such that a failure during the fastening of the abutment to the anchoring part and subsequently in the implanted state is less probable.

According to an aspect of the invention, a dental implant system includes:
an anchoring part for the anchoring in the bone tissue, wherein the anchoring part is manufactured of a ceramic material and defines an axis,
wherein the anchoring part includes a recess that is open towards a coronal end, for the engagement of a fastening post of an abutment,
an abutment of a ceramic material, with a fastening post for engaging into the recess,
and an abutment screw,
wherein the abutment includes an opening that is continuous (a through opening) in the axial direction and into which an abutment screw can be inserted, wherein the abutment screw is configured, for a fastening of the abutment to the anchoring part, to engage into an inner thread, which is formed on the anchoring part in the recess or is present on an insert element, which is inserted into the recess,
wherein the abutment screw includes a screw head,
and wherein a shoulder, which is formed coronally and which together with the screw head forms a stop on inserting the screw into the opening, is present in the opening.

In particular, the system is characterised in that the screw head and the shoulder interact such that a rotating-in of the screw up to the stop results in a wedging connection between the shoulder and the screw head.

This wedging connection can result, for example, by way of a fillet, which has a concave curvature in the longitudinal section and which, on pressing the screw against the stop, is pressed against a peripheral edge of the shoulder being formed between an apically facing screw head shoulder, which forms the apical delimitation of the screw head, and a screw shank apically of the screw head.

Such a fillet is an example of a transition region between the screw shank and an apical surface of the screw head, wherein in this intermediate region, the normal to the surface of the abutment screw is at an angle to the normal to the screw shank, which is different from 0°, as well as at an angle to the normal to the apical surface of the screw head, which is different from 0°. The peripheral edge contacts the abutment screw in this transition region.

In the present context, a “shoulder” is to be understood as a step that is arranged peripherally around the axis of the continuous opening.

What is meant by a “longitudinal section” is a section along a plane that is led through the axis and is parallel to this.

In particular, the wedging connection can be effected by way of a jamming of the screw with the abutment, indeed for example by way of the edge of the screw being pressed into the fillet (or into another transition region) in the abutment or conversely by way of a screw head shoulder, which is formed by the screw being pressed into an abutment transition region between an opening, which passes through an essentially vertical portion of the wall and the shoulder. Such an abutment transition region can also be designed as a hollow fillet, and a normal to the surface is also defined in such an abutment transition region, the normal being at an angle (different from 0°) to the normal to the vertical portion as well as at an angle (different from 0°) to the normal to the shoulder.

In particular, the wedging connection can mean that between the screw head and the abutment are pressed against each other along a line when the screw is screwed up to the stop, especially resulting in an interference fit along such line.

This means that a reverse arrangement with a peripheral edge of the screw head being pressed into a fillet of the abutment would also be conceivable.

Instead of a fillet, the abutment screw or the abutment can also include a conical portion at the respective location of the abutting of the edge (i.e. the transition region or the abutment transition region is conical). Preferably, the normal to the surface of the abutment screw or of the abutment at the location of the contact by the edge of the abutment or of the abutment screw has a relatively large angle to the axis, is therefore not parallel to this and also not even approximately parallel to this, so that the mentioned wedging connection results. The angle can be, for example, at least 30° or at least 45°.

As a whole therefore, the wedging connection can be effected by way of an abutting of a peripheral edge of the abutment or of the screw head on a fillet-like or conical transition region of the screw head or of the abutment.

The effect of this wedging is that the abutment screw is wedged at the apical end of the screw head on reaching the stop and a further rotation movement, which would effect a further rotating-in apically, is therefore prevented by the wedging (in particular jamming). A problem is solved on account of this, in contrast to solutions according to the state of the art, concerning which it is merely the apical contact surface, which is formed by the screw head, which is pressed extensively against the shoulder of the abutment for forming the stop. Specifically, on account of the procedure according to the invention, one can avoid the screw thread being able to rotate in further after reaching the stop on screwing in the abutment screw and therefore one can prevent significant stresses, also in the axial direction, from being able to arise, such stresses able to finally cause a material failure, for example in the region of the screw shank or in the region of the transition between the screw shank and the screw head.

This procedure is therefore also suitable in particular for fully ceramic systems, concerning which the abutment screw is manufactured of a ceramic material.

In particular, the anchoring part can include an outer thread, by way of which it is implanted. In this case, the axis of the anchoring part corresponds to the thread axis.

Apart from an inner thread region—in which the inner thread is present or an insert element that includes the inner thread can be inserted—the recess of the anchoring part can also include a, for example, conical support region, into which a, for example, likewise conical support portion of the abutment engages. Such a, for example, conical support region, compared to an abutting of the abutment on a horizontal (i.e. perpendicular to the axis) abutting surface of the anchoring part, firstly has the advantage that it acts with an improved sealing. Secondly, it interacts with the wedging connection of the type which is described here in a particularly advantageous manner by way of the force being continuously increased given the abutting of the screw on the stop.

In addition or as an alternative, the recess can also include an inner structure region with an insertion geometry (rotating-in geometry) for interacting with an insertion tool (rotating-in tool or abutment driver) and/or a rotational lock structure of the abutment. In particular, the recess, from coronally to apically, can firstly form the support region, then the inner structure region and then an inner thread region.

Apart from the implant and the abutment, the system can also include an insertion tool.

The ceramic material of the anchoring part (and possibly of the abutment) can be an oxide ceramic, for example a ceramic based on zirconium oxide, in particular a zirconium-oxide-based ceramic which is yttrium-stabilised. Ceramics based on aluminium oxide can also be used.

The anchoring part can in particular be designed as a bone-level anchoring part (subgingival implant), i.e. in its entirety it belongs to the enossal part of the implant system and is shaped such that it is envisaged for being sunk down to the bone crest height, which for example excludes the presence of a coronal (transgingival) region, which widens substantially with respect to the thread. However, it can also be designed differently, for example as a tissue-level anchoring part.

The arrangement of the insertion geometry apically of the support region permits a force transmission into a region that is already arranged enossally during the rotating-in. Apart from the aforementioned advantages, this creates the further advantage that a twisting of the implant can be prevented by way of this.

The possibly present insertion geometry (i.e. the axial region (insertion geometry region) of the recess, in which the insertion geometry is arranged) in its axial course can in particular be cylindrical, i.e. translationally symmetrical along the axis or, for example, be conical or concave or possibly convex. In a cross section perpendicular to the axis, the insertion geometry according to definition is not rotationally symmetrical. In particular, the inner structure can have an n-fold rotation axis in the region of the insertion geometry, wherein n is a natural number larger than 1. An oval, polygonal shapes (triangle, rectangle, pentagon, hexagon, etc.) possibly with rounded corners, a curve of constant thickness, a star shape or flower shape are examples of insertion geometry cross-sectional shapes.

The outer structure of the engagement portion of the possibly present insertion tool corresponds, for example, essentially to the insertion geometry, so that an accurately fitting insertion is possible; the insertion geometry and the engagement portion can therefore correspond to one another in their cross-sectional shape. However, one does not rule out the outer structure of the insertion tool only regionally following the insertion geometry. For example, the engagement portion does not necessarily need to extend to into outermost edges and/or a regular external hexagon can be fitted into an equilateral triangle. Preferably however, it is often the case that as large as possible a force transmission surface is present.

The support region can be rotationally symmetrical, in contrast to the insertion geometry. In particular, the support region can be conical as already mentioned, but can also be concave in a beaker-like manner or possibly convex, and a course that is at least regionally cylindrical is also possible.

The support region can encompass the abutment in an accurately fitting manner, by which means a sealing of the recess is also rendered possible. The implant can include in particular an inner cone in the support region, wherein the abutment in an apical region can include a support portion that forms a corresponding outer cone. The inner cone and the outer cone each form at least one conical wedging surface, these being adapted to one another in pairs, by which means the implant and the abutment can be connected to one another by a wedging connection. A positionally stable, sealed connection between the anchoring part and the abutment, the connection counteracting relative movements between the implant and the anchoring part, forms between the inner cone and outer cone. In the ideal case, this forms a barrier with respect to bacteria, germs and particles.

In embodiments, the abutment includes a rotation lock structure that engages into the insertion geometry in the put-together state. This structure can likewise engage into the insertion geometry in an accurately fitting manner. In alternative embodiments, one can envisage the rotation lock structure having an x·n-digit rotation geometry about the axis, wherein x is a natural number that is larger than one. In these embodiments, a rotation position of the abutment with respect to the implant can be fixed in n times x discrete rotation positions by way of receiving the rotation lock structure of the abutment into the insertion geometry. This can be advantageous if, for reasons of a favourable as possible force introduction on rotating in, the insertion geometry (rotating-in geometry) has a low rotation symmetry (for example a merely three-fold one). Due to this approach, despite this, many possible relative rotation positions are possible, which can always be of significance if the abutment is angled or has a structure which otherwise deviates from the rotation symmetry about the axis (disregarding the rotation lock structure).

The implant system can further include a cap for the process of ingrowth, via which cap the gingiva is sutured after the implantation of the anchoring part, until the implant (anchoring part) has healed in, and/or at least one gingiva shaper, which is temporarily fastened to the anchoring part instead of the abutment and permits an ongrowth of the gingiva in the shape that is to be desired later. The cap and/or the gingiva shaper can be ceramic or also be manufactured of a suitable plastic, and metallic embodiments are also considered for these temporary elements.

In this text, the terms “coronally” and “apically” with regard to the elements of the implant system are used as is the case for the implanted state, in which the anchoring part is screwed into the jawbone and the abutment (and possibly the superstructure) is fastened to the anchoring part, analogously to the natural tooth, i.e. “apically” is the direction towards the root tip, into the inside of the jawbone and “coronally” is the opposite direction towards the tooth crown.

### BRIEF DESCRIPTION OF THE DRAWINGS

The subject-matter of the invention is hereinafter represented by way of preferred embodiment examples which are represented in the accompanying drawings. In part, scales which are different from figure to figure are shown:

FIG. 1 an implant system with an anchoring part, abutment, abutment screw and screw tool, in a front elevation;

FIG. 2 a sectioned representation (sectioned parallel to the axis) of the system according to FIG. 1;

FIG. 3 a representation according to FIG. 2 of the system during the putting-together;

FIG. 4 a variant of the implant system, without a screwing tool;

FIG. 5 a sectioned representation according to FIG. 4;

FIG. 6 a view of the put-together implant system of FIGS. 4 and 5;

FIG. 7 a sectioned representation according to FIG. 6; and

FIG. 8 a detail of FIG. 7

### DETAILED DESCRIPTION OF THE INVENTION

In the figures, the same reference numerals indicate equal or analogous parts.

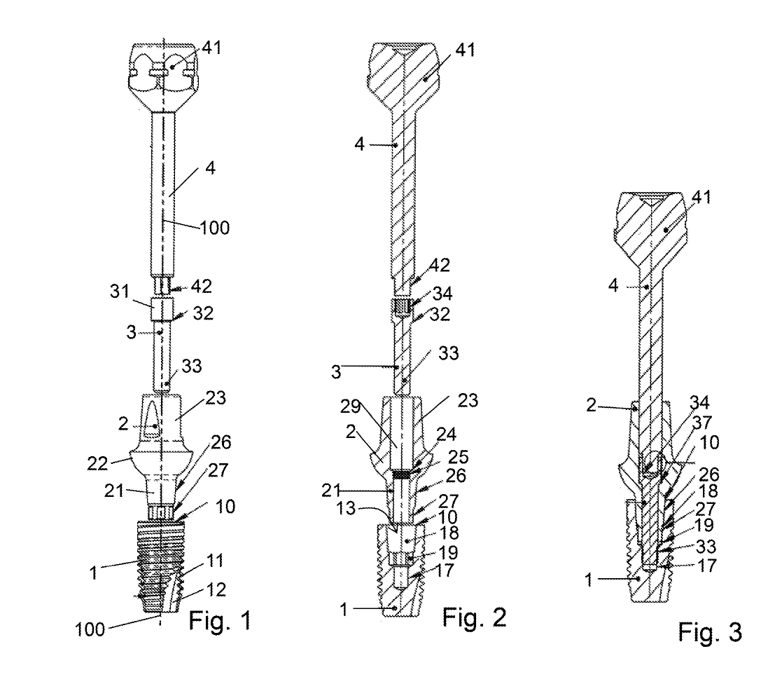

The dental implant (anchoring part 1), which, for example, is represented in FIGS. 1-3, includes an outer thread 11 that extends over almost the entire length, almost up to the coronal end, and defines an axis 100. The anchoring part 1 has an apically slightly tapering shape, so that in cross section along a plane parallel to the axis 100 as a whole it is slightly convexly curved with the exception of thread deepenings and apical clamping grooves 12 and as a whole merges continuously from a coronally roughly cylindrical into an apically tapering shape. The outer thread 11 has a non-constant thread depth and is designed, for example, in a self-tapping manner.

A recess 13, into which a fastening post 21 of an abutment 2 projects in the completed, implanted state, is open towards the coronal end. The recess forms a coronal support region 18, apically of this an insertion geometry region 19 and apically of this an inner thread region 17. The support region 18 as a whole has a conical course with a coronally slightly widening diameter. In the insertion geometry region 19, the recess forms an insertion geometry by way of it not running rotationally symmetrically about the axis 100. In the represented embodiment example, an equilateral hexagon with rounded corners is formed in the cross section along a plane perpendicular to the axis, wherein it is cylindrical in the sense that it has a constant cross section along the axis. The inner threaded region is provided with an inner thread that is matched to a screw thread of the abutment screw.

In the represented embodiment example, the anchoring part is a bone-level implant, concerning which the implant shoulder 10 with a circular edge which terminates the inner connection between the anchoring part 1 and the abutment 2 is at bone-level. The invention however can also be applied to other two-part implant systems, specifically to tissue-level implants, concerning which, for example, a transgingival region that is widened, for example, in a tulip-like manner, is formed on the anchoring part coronally of the enossal part with the thread.

Apart from the fastening post 21, the abutment 2 includes a coronal post 23 for fastening a superstructure. A transgingival region 22, which is adapted, for example, to the expected course of the gingiva, is formed apically of this. The shapes of such a transgingival region 22 as well as of the post 23—here drawn with an optional flattening—including its angle to the fastening post and therefore to the axis 100 are adapted to the specific requirements and depending on where the implant is placed or has been placed in the jaw. In particular, an implantation set with at least one anchoring part can include several different abutments for different implantation situations.

A support portion 26, which in its shape is matched to the support region 18, is formed on the fastening post 21, and a rotation lock structure 27 is formed apically of this. The rotation lock structure has a hexagonal shape, likewise with rounded edges.

The abutment includes an axially continuous opening 29 for the abutment screw. This further forms a shoulder 24 for the head of the abutment screw. Furthermore, an optional abutment inner thread 25 for a so-called retrieval tool (a tool for removing the abutment) is present at the opening.

The abutment screw 3 has a shank region with the outer thread 33 that is matched to the inner thread of the anchoring part, as well as a screw head 31, which forms a screw stop 32 in the apical direction. A coronally open recess with an engagement structure 34, designed here in the shape in an internal hex, for a screwdriver 4, is formed in the screw head. The screwdriver 4 accordingly includes an engagement portion, in the represented example, with a hexagonal structure. In embodiments, the engaging structure and the engagement portion taper slightly apically, i.e. are shaped in a slightly conical manner, so that the screwdriver easily wedges with the abutment screw given a slight pushing-in and therefore holds this on the screwdriver. Coronally, the screwdriver includes an adapter head 41, for example for a ratchet with an adjustable torque.

FIG. 3 shows the implant system during the procedure of the abutment fastening, before the application of the superstructure (tertiary structure). The thread 33 of the abutment screw 3 is received apically by the respective inner thread of the anchoring part 1. The abutment screw 3 fixes the abutment 2 relative to the anchoring part with regard to a pulling-apart in the axial direction. Herein, the abutment is supported and guided in the support region by way of the support portion 26 bearing extensively on the inner surface of the recess there. The abutment is secured in this position with respect to rotations, by way of the rotation lock structure 27 engaging into the coronal region of the insertion geometry.

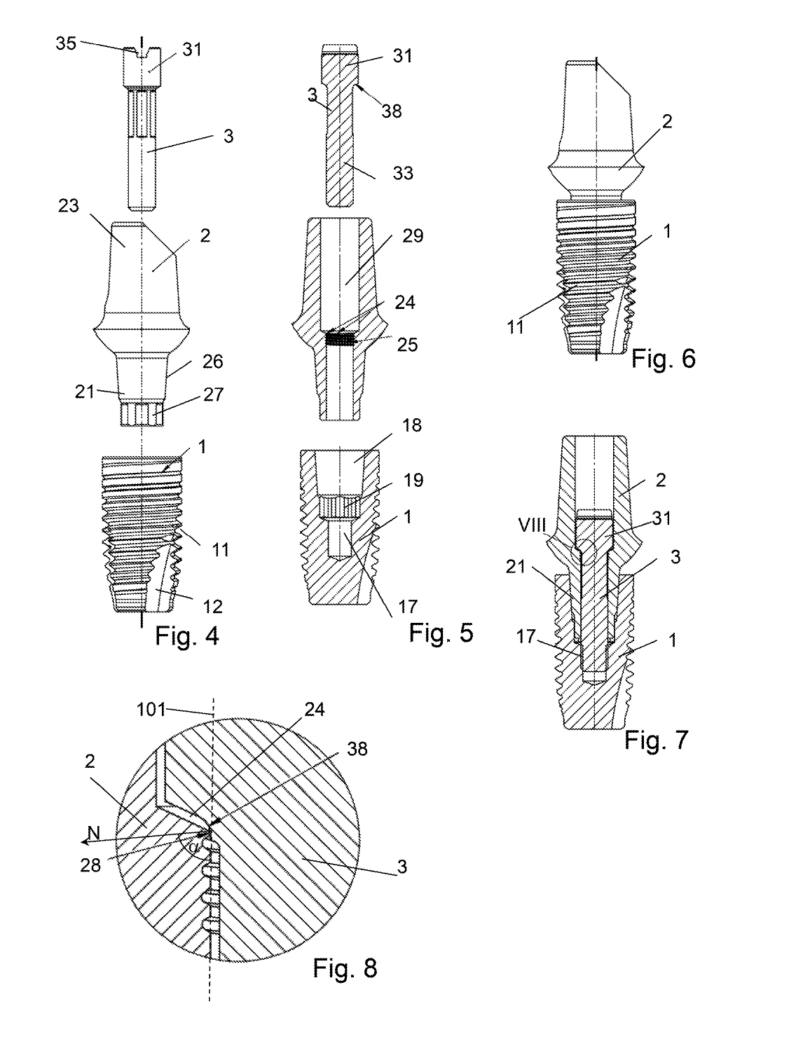

FIGS. 4-7 show the dental implant system without the screwdriver 4 and with a slightly modified abutment screw, which differs from the abutment screw of the embodiment of FIGS. 1-3, amongst other things in that the engaging structure is formed by a screw slot 35.

Furthermore, in FIG. 4 the abutment is drawn with a bevelling in the region of the coronal post 23. Generally, as is also known from the state of the art, it is particularly the coronal post of the abutment, which can be selected according to requirements and the implant situation, by which means coronal posts, which are angled to the axis, can also occur. The continuous opening however—as is known per se—will always run axially, even given an angled coronal post.

The acting principle of the wedging mechanism according to the invention can be seen particularly well in FIG. 8, which represents a detail VIII of FIG. 7 in an enlarged manner.

The shoulder 24, which is formed on the abutment in the continuous axial opening 29 ends at the inner side in an edge 28. In the put-together condition, a fillet 38 of the abutment screw 3 is pressed against this edge. By way of this, the screw cants relative to the abutment and cannot be rotated any further apically. The axial position of the fillet 38 is selected such that this forms a stop for the screw. On account of this procedure, it is ensured that a rotating-in of the screw beyond the stop is prevented by way of this canting and the wedging effect, which is produced by this. In comparison to the state of the art with a conventional abutting of an apically facing contact surface of the screw head on a shoulder of the abutment, this has the advantage that on tightening the screw against the abutment, no significant stresses can be produced in the screw in the axial direction.

The edge 28 is drawn in an idealised manner as a sharp edge in FIG. 8. In practice, the edge 28 can also be slightly rounded. However, what can be important for the wedging is that a radius of a possible such rounding (in the longitudinal section) is smaller than the radius (in the longitudinal section) of the fillet 38, whereby a line-like contact results.

Furthermore, it is preferably the case that a peripheral line, along which an abutting of the fillet on the edge takes place, is still effected within the fillet, i.e. within that region, at which the screw is concavely rounded in cross section. By way of this, there also results the advantage of this line not having to be precisely defined on the screw itself, i.e. the procedure is also advantageous with regard to manufacturing tolerances.

A normal N to the surface of the abutment screw at the location of contact with the abutment generally has a comparatively large angle α to the axis, for example at least 30° or at least 45° or even at least 55°. In particular, the normal is neither parallel nor approximately parallel to the axis. An auxiliary line 101 is drawn parallel to the axis in FIG. 8 in order to illustrate the angle α. This possible condition for the angle of the normal is also valid if a conical portion is present instead of a fillet.

In the described embodiments, the abutment screw engages into the inner thread 17, which is directly present in the anchoring part. However, the principle of the present invention could also be transferable to a system, concerning which the thread is formed by a separate insert element that is inserted into the recess, as is taught in EP 2 878 280 or in WO 2017/096494.

1. A dental implant system, comprising:
an anchoring part for the anchoring in the bone tissue, wherein the anchoring part is manufactured of a ceramic material and defines an axis,
an abutment of a ceramic material,
wherein the anchoring part comprises a recess which is open towards a coronal end, for a fastening post of an abutment to engage,
and an abutment screw,
wherein the abutment comprises an opening being continuous in the axial direction and being shaped for an abutment screw to be inserted, wherein the abutment screw is configured, for a fastening of the abutment to the anchoring part, to engage into an inner thread which is formed on the anchoring part in the recess or is present on an insert element which is inserted into the recess,
wherein the abutment screw comprises a screw head,
and wherein a shoulder which is formed coronally and which together with the screw head forms a stop on inserting the screw into the opening is present in the opening,
wherein the screw head and the shoulder interact such that a rotating-in of the screw up to the stop results in a wedging connection between the shoulder and the screw head.

2. The system according to claim 1, wherein the wedging connection is effected by way of an abutting of a peripheral edge of the abutment or of the screw head on a fillet-like or conical transition region of the screw head or of the abutment, respectively.

3. The system according to claim 1, wherein a fillet which has a concave curvature in the longitudinal section and which on pressing the screw against the stop is pressed against a peripheral edge of the shoulder is formed between the screw head and a screw shank which is arranged apically of this screw head.

4. The system according to claim 1, wherein the wedging connection is effected by way of a jamming of the screw head with the abutment.

5. The system according to claim 4, wherein the abutment forms a peripheral edge and a normal to the surface of the abutment screw at the location of contact to the edge has an angle of at least 30° to the axis.

6. The system according to claim 1, wherein the abutment screw is manufactured from a ceramic material.

7. The system according to claim 1, wherein the anchoring part comprises an outer thread whose thread axis corresponds to the axis.

8. The system according to claim 1, wherein the recess forms a conical support region, into which a conical support portion of the abutment engages.

9. The system according to claim 1, wherein the recess comprises an inner structure region with an inner structure which forms an insertion geometry for interacting with a corresponding rotation lock structure of the abutment.

10. The system according to claim 8, wherein the recess from coronally to apically firstly forms the support region, then the inner structure region and then an inner threaded region.

11. The system according to claim 9, further comprising an insertion tool with an engagement portion which comprises an outer structure which is adapted for engagement into the inner structure.

12. The system according to claim 1, wherein the anchoring part is designed as a bone-level anchoring part.
